(19) United States
(12) Patent Application Publication
(10) Pub. No.: US 2025/0313963 A1
(43) Pub. Date: Oct. 9, 2025

(54) METHODS OF FORMING SULFUR AND HYDROGEN FROM HYDROGEN SULFIDE

(71) Applicant: Saudi Arabian Oil Company, Dhahran (SA)

(72) Inventors: Martin Velazquez Rizo, Jeddah (SA); Adrian Cesar Cavazos Sepulveda, San Pedro Garza García (MX)

(21) Appl. No.: 18/626,924

(22) Filed: Apr. 4, 2024

(51) Int. Cl. C25B 1/02; C25B 11/042; C25B 15/021; C25B 15/08

(52) U.S. Cl. CPC C25B 1/02; C25B 11/042; C25B 15/021; C25B 15/083

(57) ABSTRACT

This disclosure relates to methods of forming elemental sulfur and hydrogen gas from hydrogen sulfide. The disclosed methods include contacting a solution including hydrogen sulfide with an electrode for hydrogen evolution and an electrode for sulfur oxidation.

### TECHNICAL FIELD

This document relates to methods of forming elemental sulfur and hydrogen gas from hydrogen sulfide. The disclosed methods include contacting a solution including hydrogen sulfide with an electrode for hydrogen evolution and an electrode for sulfur oxidation.

### BACKGROUND

Natural gas supplies over 20% of the energy used worldwide and makes up nearly a quarter of electricity generation, and also plays a crucial role as a feedstock for industry. Raw natural gas typically contains about 50-90% methane (CH₄) as the primary component, with the remaining components being heavier hydrocarbons and undesired impurities. Among the various impurities that must be removed before the sale and use of natural gas, acidic components, such as hydrogen sulfide (H₂S) and carbon dioxide (CO₂), are removed with higher priority due to their corrosive nature. For example, for transportation and use in the United States, the concentration of H₂S must be less than 4 part per million (ppm) in a pipeline. As such, both H₂S must be removed from the raw gas to produce clean and commercially viable product.

The standard industrial treatment of raw natural gas is a desulfurizing method called the Claus process, which converts H₂S and oxygen into elemental sulfur and water. However, the Claus process has a number of drawbacks, including large investment and operational costs (e.g. special chemicals, equipment corrosion, high pressures and temperatures), require special operational safety and health procedures, and production of waste products (e.g. spent chemical solutions or spent activated carbon). Additionally, the Claus process only produces sulfur as a commodity and not any additional valuable by-products, such as hydrogen gas. Electrochemical processes are also employed in the treatment of hydrogen sulfide. However, many electrochemical processes require a precious metal electrode which may be deactivated due to sulfur passivation.

Therefore, there is a need for new methods for decomposing hydrogen sulfide that are more efficient and require lower upkeep and operational costs.

### SUMMARY

Provided in the present disclosure are methods of forming hydrogen (H₂) and sulfur(S) from hydrogen sulfide (H₂S), the method including contacting an ionic-conductive liquid solution including hydrogen sulfide with an electrode for H₂ evolution reaction (HER) and an electrode for sulfur oxidation reaction (SOR) in an electrochemical cell; and forming the hydrogen and the sulfur.

In some embodiments, the method further includes isolating the hydrogen and the sulfur.

In some embodiments, the method further includes forming the ionic-conductive liquid solution, including bubbling hydrogen sulfide through an ionic-conductive liquid.

In some embodiments, the method further includes applying direct current (DC), alternating current (AC), or both to the electrode for HER and the electrode for SOR.

In some embodiments, the ionic-conductive liquid is an ionic liquid, a natural deep eutectic solvent, a deep eutectic solvent, an organic solvent, an inorganic solvent, or a combination thereof.

In some embodiments, the ionic-conductive liquid includes a deep eutectic solvent and an ionic liquid.

In some embodiments, the ionic-conductive liquid includes water.

In some embodiments, the ionic-conductive liquid solution is in direct contact with both the electrode for HER and the electrode for SOR.

In some embodiments, the ionic-conductive liquid solution is in indirect contact with one or both of the electrode for HER and the electrode for SOR.

In some embodiments, the electrode for HER includes carbon and/or a metal selected from platinum (Pt), rhodium (Rh), gold (Au), silver (Ag), palladium (Pd), nickel (Ni), and iridium (Ir).

In some embodiments, the electrode for HER includes carbon and/or a metal selected from platinum (Pt), rhodium (Rh), and palladium (Pd).

In some embodiments, the electrode for SOR includes lithium (Li), sodium (Na), potassium (K), rubidium (Rb), cesium (Cs), francium (Fr), beryllium (Be), magnesium (Mg), calcium (Ca), strontium (Sr), barium (Ba), radium (Ra), gallium (Ga), oxygen (O), sulfur(S), selenium (Se), tellurium (Te), polonium (Po), or a combination thereof.

In some embodiments, the electrode for SOR includes beryllium (Be), magnesium (Mg), calcium (Ca), sulfur(S), zinc (Zn), cadmium (Cd), oxygen (O), tellurium (Te), or a combination thereof.

In some embodiments, the dopant includes lithium (Li), sodium (Na), potassium (K), scandium (Sc), yttrium (Y), nitrogen (N), phosphorus (P), arsenic (As), fluorine (F), chlorine (Cl), and combinations thereof.

In some embodiments, the method includes applying sonication or ultrasonication to the electrochemical cell.

In some embodiments, the electrode for SOR includes beryllium (Be), magnesium (Mg), calcium (Ca), sulfur(S), zinc (Zn), cadmium (Cd), oxygen (O), tellurium (Te), or a combination thereof; and the ionic-conductive liquid solution further includes a dopant or dopant precursor selected from lithium (Li), sodium (Na), potassium (K), rubidium (Rb), cesium (Cs), francium (Fr), scandium (Sc), Yttrium (Y), lutetium (Lu), lawrencium (Lr), vanadium (V), niobium (Nb), tantalum (Ta), manganese (Mn), technetium (Tc), rhenium (Rh), nitrogen (N), phosphorus (P), arsenic (As), fluorine (F), chlorine (Cl), and combinations thereof.

In some embodiments, the dopant or dopant precursor and hydrogen sulfide are present in the ionic-conductive liquid solution in a molar ratio of about 10⁻⁷ to 1 to about 10⁻¹ to 1.

In some embodiments, the method further includes dissolving the sulfur formed on the electrode for SOR, including applying a direct current (DC) or an alternating current (AC) to the electrode for SOR, or increasing the temperature of the ionic-conductive liquid solution.

In some embodiments, the method further includes precipitating the sulfur from the ionic-conductive liquid solution by decreasing the temperature of the ionic-conductive liquid solution.

Also provided in the present disclosure are methods of forming hydrogen (H₂) and sulfur(S) from hydrogen sulfide (H₂S), including forming the ionic-conductive liquid solution including hydrogen sulfide; contacting an ionic-conductive liquid solution with an electrode for H₂ evolution reaction (HER) and an electrode for sulfur oxidation reaction (SOR) in an electrochemical cell; applying direct current (DC), alternating current (AC), or both to the electrode for HER and the electrode for SOR, and/or applying sonication to the electrochemical cell; forming the hydrogen and the sulfur; dissolving the sulfur formed on the electrode for SOR; precipitating the sulfur from the ionic-conductive liquid solution by decreasing the temperature of the ionic-conductive liquid solution; and isolating the hydrogen and the sulfur.

### DESCRIPTION OF DRAWINGS

FIG. 1 shows a schematic representation of an exemplary electrochemical cell for performing the disclosed methods, where I represents an electrode for sulfur oxidation reaction (SOR); II represents an electrode for hydrogen evolution reaction (HER); III represents a hydrogen sulfide-containing ionic-conductive liquid solution; IV represents an ion-conductive material and/or separator; V represents an electrolyte for hydrogen evolution reaction (HER), which may be the same as the hydrogen sulfide-containing ionic-conductive liquid solution represented by III; VI represents an alternating current/direct current (AC/DC) voltage source; and VII represents a temperature and pressure-controlled electrochemical cell, coupled with ultrasonic capabilities.

FIG. 2 shows a schematic representation of an exemplary electrochemical cell for performing the disclosed methods, where I represents an electrode for sulfur oxidation reaction (SOR) including, for example, magnesium sulfide (MgS); II represents an electrolyte for hydrogen evolution reaction (HER) including, for example, platinum (Pt); III represents the ionic-conductive liquid solution including H₂S; IV represents an alternating current/direct current (AC/DC) voltage source with a current passing between the HER and SOR electrodes; V represents a temperature- and pressure-controlled electrochemical cell, coupled with ultrasonic capabilities; and VI represents hydrogen gas (H₂) obtained from the electrode for HER.

FIG. 3 shows a schematic representation of an exemplary electrochemical cell for performing the disclosed methods, where I represents an electrode for sulfur oxidation reaction (SOR) including, for example, magnesium sulfide (MgS); II represents an electrolyte for hydrogen evolution reaction (HER) including, for example, platinum (Pt); III represents the ionic-conductive liquid solution including H₂S; IV represents an alternating current/direct current (AC/DC) voltage source with a current passing between the HER and SOR electrodes; V represents a temperature- and pressure-controlled electrochemical cell, coupled with ultrasonic capabilities; VI represents hydrogen gas (H₂) obtained from the electrode for HER; and VII represents an ion-conductive material and/or separator.

FIG. 4 shows a schematic representation of an exemplary electrochemical cell for performing the disclosed methods, where I represents the introduction of a gas stream containing H₂S; II represents H₂S-free gas obtained from the electrochemical cell; III represents the ionic-conductive liquid solution; and IV represents a temperature- and pressure-controlled electrochemical cell, coupled with ultrasonic capabilities.

FIG. 5 shows a schematic representation of an exemplary electrochemical cell for performing the disclosed methods, where I represents an electrode for sulfur oxidation reaction (SOR) including, for example, magnesium sulfide (MgS), after sulfur-based material deposition; II represents a counter electrode, which may be the original electrode for HER; III represents the ionic-conductive liquid solution including H₂S; IV represents an alternating current/direct current (AC/DC) voltage source with a current passing between the HER and SOR electrodes; V represents a temperature- and pressure-controlled electrochemical cell, coupled with ultrasonic capabilities.

FIG. 6 shows a schematic representation of an exemplary electrochemical cell for performing the disclosed methods, where I represent the removal of precipitated sulfur; II represents the ionic-conductive liquid solution including precipitated sulfur; and III represents a temperature- and pressure-controlled electrochemical cell, coupled with ultrasonic capabilities.

### DETAILED DESCRIPTION

The present disclosure relates to methods of forming hydrogen (H₂) and sulfur(S) from hydrogen sulfide (H₂S), the method including contacting an ionic-conductive liquid solution including hydrogen sulfide with an electrode for hydrogen evolution reaction (HER) and an electrode for sulfur oxidation reaction (SOR) in an electrochemical cell; and forming the hydrogen and the sulfur. The present method decomposes hydrogen sulfide to produce both elemental sulfur and hydrogen gas, both commercially valuable by-products.

The present disclosure relates to methods of forming hydrogen (H₂) and sulfur(S) from hydrogen sulfide (H₂S) where the sulfur oxidation reaction (SOR) electrode contains at least one element from the alkali metals group, alkaline earth metals group, or group 12 elements, alone or in combination with sulfur or another chalcogen element. The present disclosure relates to methods of forming hydrogen (H₂) and sulfur(S) from hydrogen sulfide (H₂S) where the electrode for hydrogen evolution reaction (HER) contains carbon and/or a metal. The present disclosure relates to methods of forming hydrogen (H₂) and sulfur(S) from hydrogen sulfide (H₂S) that do not require the use of precious metal electrodes, thereby reducing the cost of hydrogen sulfide treatment.

The present disclosure relates to methods of forming hydrogen (H₂) and sulfur(S) from hydrogen sulfide (H₂S) which demands lower energy consumption than current industrial H₂S decomposition methods, as it is performed at lower temperatures and standard atmospheric pressure, which also facilitates its practical implementation.

The present disclosure relates to methods of forming hydrogen (H₂) and sulfur(S) from hydrogen sulfide (H₂S) which is resistant to passivation or deactivation of the electrodes for hydrogen evolution reaction (HER) and sulfur oxidation reaction (SOR). The present disclosure relates to methods of forming hydrogen (H₂) and sulfur(S) from hydrogen sulfide (H₂S) where a dopant or a dopant precursor may be added to the ionic-conductive liquid solution including hydrogen sulfide to achieve the doping of the group II-sulfur compound formed at the sulfur oxidation reaction (SOR) electrode surface during its deposition to obtain an n- or p-type conductivity. In some embodiments, the addition of a dopant or a dopant precursor to the ionic-conductive liquid solution including hydrogen sulfide reduces or prevents electrical passivation of the sulfur oxidation reaction (SOR). In some embodiments, the addition of a dopant or a dopant precursor to the ionic-conductive liquid solution including hydrogen ensures the continuous oxidation and formation of elemental sulfur. In some embodiments, a reversible reaction is driven in the sulfur oxidation reaction (SOR) electrode by applying a suitable direct current (DC), alternating current (AC), or combination of AC/DC voltage to the SOR to separate sulfur adsorbed onto the SOR. In some embodiments, a reversible reaction is driven in the sulfur oxidation reaction (SOR) electrode by applying a suitable direct current (DC), alternating current (AC), or combination of AC/DC voltage to the SOR to desorb the sulfur from the SOR. In some embodiments, the temperature of the ionic-conductive liquid solution is increased to increase sulfur solubility in the ionic-conductive liquid solution. In some embodiments, the temperature of the ionic-conductive liquid solution is increased to separate sulfur adsorbed onto the SOR. In some embodiments, the temperature of the ionic-conductive liquid solution is increased to desorb the sulfur from the SOR.

In some embodiments, a reverse reaction is performed to regenerate the sulfur oxidation reaction (SOR) electrode.

The present disclosure relates to methods of forming hydrogen (H₂) and sulfur(S) from hydrogen sulfide (H₂S) which may be used to treat a wide range of H₂S concentrations in gas streams. In some embodiments, the present method is used to treat petroleum samples containing a low concentration of hydrogen sulfide. In some embodiments, the present method is used to treat petroleum samples containing a high concentration of hydrogen sulfide.

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

### Definitions

In this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about” as used herein can allow for a degree of variability in a value or range, for example, within 10%, within 5%, or within 1% of a stated value or of a stated limit of a range.

In the methods described in the present disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

### Methods of Forming Hydrogen and Sulfur

The present disclosure relates to methods of forming hydrogen (H₂) and sulfur(S) from hydrogen sulfide (H₂S), the method including:
contacting an ionic-conductive liquid solution including hydrogen sulfide with an electrode for hydrogen evolution reaction (HER) and an electrode for sulfur oxidation reaction (SOR) in an electrochemical cell; and
forming the hydrogen and the sulfur.

In some embodiments, the method further includes forming the ionic-conductive liquid solution including hydrogen sulfide.

In some embodiments, forming the ionic-conductive liquid solution includes bubbling hydrogen sulfide through an ionic-conductive liquid.

In some embodiments, the ionic-conductive liquid is an ionic liquid, a natural deep eutectic solvent, a deep eutectic solvent, an organic solvent, an inorganic solvent, or a combination thereof. In some embodiments, the ionic-conductive liquid is an ionic liquid. In some embodiments, the ionic-conductive liquid is a natural deep eutectic solvent. In some embodiments, the ionic-conductive liquid is a deep eutectic solvent. In some embodiments, the ionic-conductive liquid is an organic solvent. In some embodiments, the ionic-conductive liquid is an inorganic solvent.

In some embodiments, the ionic-conductive liquid is water.

In some embodiments, the inorganic solvent is a molten salt or a molten semiconductor. In some embodiments, the inorganic solvent is a molten salt. In some embodiments, the inorganic solvent is a molten semiconductor.

In some embodiments, the ionic-conductive liquid is a combination of a deep eutectic solvent and an ionic liquid.

In some embodiments, the ionic liquid further includes one or more additives to increase sulfur solubility. In some embodiments, the one or more additives includes a sterically hindered amine. In some embodiments, the one or more additives includes monoethanolamine, diethanolamine, triethanolamine, and combinations thereof.

In some embodiments, the method further includes applying direct current (DC), alternating current (AC), or both to the electrode for HER and the electrode for SOR, and/or applying sonication to the electrochemical cell. In some embodiments, the method further includes applying direct current (DC) to the electrochemical cell. In some embodiments, the method further includes applying alternating current (AC), or both to the ionic-conductive liquid solution. In some embodiments, the method further includes applying sonication to the electrochemical cell. In some embodiments, the method further includes applying direct current (DC) or alternating current (AC), and applying sonication to the electrochemical cell. In some embodiments, the method further includes applying direct current (DC) sonication to the electrochemical cell. In some embodiments, the method further includes applying alternating current (AC) sonication to the electrochemical cell.

In some embodiments, direct current (DC) is applied at an electric current density of about 0.1 to about 500 mAcm⁻². In some embodiments, alternating current (AC) is applied at an electric current density of about 0.1 to about 500 mAcm⁻².

In some embodiments, direct current (DC) is applied at a voltage of about 0.1 to about 20 V. In some embodiments, alternating current (AC) is applied at a voltage of about 0.1 to about 20 V.

In some embodiments, the temperature of the ionic-conductive liquid solution is increased to about 40° C. to about 90° C. In some embodiments, the temperature of the ionic-conductive liquid solution is increased to about 40° C. or greater.

In some embodiments, the sonication is applied at a frequency of about 2 to about 80 kHz. In some embodiments, the sonication is ultrasonication.

In some embodiments, the sonication is applied to the electrode for HER and/or the electrode for SOR. In some embodiments, the sonication is applied to the electrode for HER. In some embodiments, the sonication is applied to the electrode for SOR. In some embodiments, the sonication is applied to the electrode for HER and the electrode for SOR.

In some embodiments, the method further includes dissolving the sulfur formed on the electrode for SOR. In some embodiments, dissolving the sulfur includes applying a direct current (DC) or an alternating current (AC) to the electrode for SOR, or increasing the temperature of the ionic-conductive liquid solution. In some embodiments, dissolving the sulfur includes applying a direct current (DC) to the electrode for SOR. In some embodiments, dissolving the sulfur includes applying an alternating current (AC) to the electrode for SOR. In some embodiments, dissolving the sulfur includes increasing the temperature of the ionic-conductive liquid solution.

In some embodiments, the method further includes precipitating the sulfur from the ionic-conductive liquid solution by decreasing the temperature of the ionic-conductive liquid solution. In some embodiments, the method further includes precipitating the sulfur from the ionic-conductive liquid solution by decreasing the temperature of the ionic-conductive liquid solution to about 5° C. to about 40° C.

In some embodiments, the method further includes isolating the hydrogen and the sulfur.

In some embodiments, the contacting occurs at a temperature of about 5° C. to about 200° C. In some embodiments, the contacting occurs at a temperature of about 5° C. to about 180° C. In some embodiments, the contacting occurs at a temperature of about 5° C. to about 160° C. In some embodiments, the contacting occurs at a temperature of about 5° C. to about 140° C. In some embodiments, the contacting occurs at a temperature of about 5° C. to about 120° C. In some embodiments, the contacting occurs at a temperature of about 5° C. to about 100° C. In some embodiments, the contacting occurs at a temperature of about 5° C. to about 80° C. In some embodiments, the contacting occurs at a temperature of about 5° C. to about 60° C. In some embodiments, the contacting occurs at a temperature of about 5° C. to about 40° C. In some embodiments, the contacting occurs at a temperature of about 5° C. to about 20° C. In some embodiments, the contacting occurs at a temperature of about 20° C. to about 200° C. In some embodiments, the contacting occurs at a temperature of about 40° C. to about 200° C. In some embodiments, the contacting occurs at a temperature of about 60° C. to about 200° C. In some embodiments, the contacting occurs at a temperature of about 80° C. to about 200° C. In some embodiments, the contacting occurs at a temperature of about 100° C. to about 200° C. In some embodiments, the contacting occurs at a temperature of about 120° C. to about 200° C. In some embodiments, the contacting occurs at a temperature of about 140° C. to about 200° C. In some embodiments, the contacting occurs at a temperature of about 160° C. to about 200° C. In some embodiments, the contacting occurs at a temperature of about 180° C. to about 200° C.

n some embodiments, the contacting occurs at a temperature of about 20° C. to about 120° C.

In some embodiments, the contacting occurs at about 1 atm to about 150 atm pressure. In some embodiments, the contacting occurs at about 1 atm pressure. In some embodiments, the contacting occurs at above about 1 atm pressure.

In some embodiments, the method does not decompose a hydrocarbon. In some embodiments, the method does not decompose any methane, ethane, propane, butane, pentane, hexane, heptane, octane, nonane, dodecane, isobutane, ethylene, propylene, butylene, isobutylene, or combinations thereof.

In some embodiments, the ionic-conductive liquid solution is in direct contact with both the electrode for HER and the electrode for SOR.

In some embodiments, the ionic-conductive liquid solution is in indirect contact with one or both of the electrode for HER and the electrode for SOR.

In some embodiments, the indirect contact between the ionic-conductive liquid solution and the electrode for HER and/or the electrode for SOR occurs through a hydrogen ion-conductive material, a sulfur ion-conductive material, an anion exchange membrane, a proton exchange membrane, a cation exchange membrane, or an ion exchange membrane.

In some embodiments, the electrode for HER includes carbon and/or a metal. In some embodiments, the electrode for HER includes carbon and a metal. In some embodiments, the electrode for HER includes carbon. In some embodiments, the electrode for HER includes a metal.

In some embodiments, the electrode for HER includes carbon and/or a metal selected from platinum (Pt), rhodium (Rh), gold (Au), silver (Ag), palladium (Pd), nickel (Ni), and iridium (Ir).

In some embodiments, the electrode for HER includes carbon and/or a metal selected from platinum (Pt), rhodium (Rh), and palladium (Pd).

In some embodiments, the electrode for HER includes platinum (Pt). In some embodiments, the electrode for HER includes rhodium (Rh). In some embodiments, the electrode for HER includes gold (Au). In some embodiments, the electrode for HER includes silver (Ag). In some embodiments, the electrode for HER includes palladium (Pd). In some embodiments, the electrode for HER includes nickel (Ni). In some embodiments, the electrode for HER includes iridium (Ir).

In some embodiments, the electrode for HER includes carbon and/or a metal selected from platinum (Pt), rhodium (Rh), gold (Au), silver (Ag), palladium (Pd), nickel (Ni), and iridium (Ir). In some embodiments, the electrode for HER includes carbon and a metal selected from platinum (Pt), rhodium (Rh), gold (Au), silver (Ag), palladium (Pd), nickel (Ni), and iridium (Ir). In some embodiments, the electrode for HER includes carbon and platinum (Pt). In some embodiments, the electrode for HER includes carbon and rhodium (Rh). In some embodiments, the electrode for HER includes carbon and gold (Au). In some embodiments, the electrode for HER includes carbon and silver (Ag). In some embodiments, the electrode for HER includes carbon and palladium (Pd). In some embodiments, the electrode for HER includes carbon and nickel (Ni). In some embodiments, the electrode for HER includes carbon and iridium (Ir).

In some embodiments, the electrode for SOR includes an alkali metal, an alkaline earth metal, a group 12 element, a chalcogen, or a combination thereof.

In some embodiments, the electrode for SOR includes an alkali metal, an alkaline earth metal, a group 12 element, and a chalcogen. In some embodiments, the electrode for SOR includes an alkali metal. In some embodiments, the electrode for SOR includes an alkaline earth metal. In some embodiments, the electrode for SOR includes a group 12 element. In some embodiments, the electrode for SOR includes a chalcogen.

In some embodiments, the electrode for SOR includes lithium (Li), sodium (Na), potassium (K), rubidium (Rb), cesium (Cs), francium (Fr), beryllium (Be), magnesium (Mg), calcium (Ca), strontium (Sr), barium (Ba), radium (Ra), gallium (Ga), oxygen (O), sulfur(S), selenium (Se), tellurium (Te), polonium (Po), zinc (Zn), cadmium (Cd), indium (In), or a combination thereof. In some embodiments, the electrode for SOR includes lithium (Li). In some embodiments, the electrode for SOR includes sodium (Na). In some embodiments, the electrode for SOR includes potassium (K). In some embodiments, the electrode for SOR includes rubidium (Rb). In some embodiments, the electrode for SOR includes cesium (Cs). In some embodiments, the electrode for SOR includes francium (Fr). In some embodiments, the electrode for SOR includes beryllium (Be). In some embodiments, the electrode for SOR includes magnesium (Mg). In some embodiments, the electrode for SOR includes calcium (Ca). In some embodiments, the electrode for SOR includes strontium (Sr). In some embodiments, the electrode for SOR includes barium (Ba). In some embodiments, the electrode for SOR includes radium (Ra). In some embodiments, the electrode for SOR includes gallium (Ga). In some embodiments, the electrode for SOR includes oxygen (O). In some embodiments, the electrode for SOR includes sulfur(S). In some embodiments, the electrode for SOR includes selenium (Se). In some embodiments, the electrode for SOR includes tellurium (Te). In some embodiments, the electrode for SOR includes polonium (Po). In some embodiments, the electrode for SOR includes zinc (Zn). In some embodiments, the electrode for SOR includes cadmium (Cd). In some embodiments, the electrode for SOR includes indium (In).

In some embodiments, the electrode for SOR includes beryllium (Be), magnesium (Mg), calcium (Ca), sulfur(S), zinc (Zn), cadmium (Cd), oxygen (O), tellurium (Te), or a combination thereof.

In some embodiments, the ionic-conductive liquid solution further includes a dopant. In some embodiments, the ionic-conductive liquid solution further includes a dopant precursor. In some embodiments, the dopant precursor is a chemical compound including one or more dopant.

In some embodiments, the electrode for SOR includes beryllium (Be), magnesium (Mg), calcium (Ca), sulfur(S), zinc (Zn), cadmium (Cd), oxygen (O), tellurium (Te), or a combination thereof; and the ionic-conductive liquid solution further includes a dopant or a dopant precursor.

In some embodiments, the dopant is selected from lithium (Li), sodium (Na), potassium (K), rubidium (Rb), cesium (Cs), francium (Fr), scandium (Sc), Yttrium (Y), lutetium (Lu), lawrencium (Lr), vanadium (V), niobium (Nb), tantalum (Ta), manganese (Mn), technetium (Tc), rhenium (Rh), nitrogen (N), phosphorus (P), arsenic (As), fluorine (F), chlorine (Cl), and combinations thereof.

In some embodiments, the dopant precursor includes lithium (Li), sodium (Na), potassium (K), rubidium (Rb), cesium (Cs), francium (Fr), scandium (Sc), Yttrium (Y), lutetium (Lu), lawrencium (Lr), vanadium (V), niobium (Nb), tantalum (Ta), manganese (Mn), technetium (Tc), rhenium (Rh), nitrogen (N), phosphorus (P), arsenic (As), fluorine (F), chlorine (Cl), and combinations thereof.

In some embodiments, the dopant includes lithium (Li). In some embodiments, the dopant includes sodium (Na). In some embodiments, the dopant includes potassium (K). In some embodiments, the dopant includes rubidium (Rb). In some embodiments, the dopant includes cesium (Cs). In some embodiments, the dopant includes francium (Fr). In some embodiments, the dopant includes scandium (Sc). In some embodiments, the dopant includes Yttrium (Y). In some embodiments, the dopant includes lutetium (Lu). In some embodiments, the dopant includes lawrencium (Lr). In some embodiments, the dopant includes vanadium (V). In some embodiments, the dopant includes niobium (Nb). In some embodiments, the dopant includes tantalum (Ta). In some embodiments, the dopant includes manganese (Mn). In some embodiments, the dopant includes technetium (Tc). In some embodiments, the dopant includes rhenium (Rh). In some embodiments, the dopant includes nitrogen (N). In some embodiments, the dopant includes phosphorus (P). In some embodiments, the dopant includes arsenic (As). In some embodiments, the dopant includes fluorine (F). In some embodiments, the dopant includes chlorine (Cl).

In some embodiments, the dopant precursor includes lithium (Li). In some embodiments, the dopant precursor includes sodium (Na). In some embodiments, the dopant precursor includes potassium (K). In some embodiments, the dopant precursor includes rubidium (Rb). In some embodiments, the dopant precursor includes cesium (Cs). In some embodiments, the dopant precursor includes francium (Fr). In some embodiments, the dopant precursor includes scandium (Sc). In some embodiments, the dopant precursor includes Yttrium (Y). In some embodiments, the dopant precursor includes lutetium (Lu). In some embodiments, the dopant precursor includes lawrencium (Lr). In some embodiments, the dopant precursor includes vanadium (V). In some embodiments, the dopant precursor includes niobium (Nb). In some embodiments, the dopant precursor includes tantalum (Ta). In some embodiments, the dopant precursor includes manganese (Mn). In some embodiments, the dopant precursor includes technetium (Tc). In some embodiments, the dopant precursor includes rhenium (Rh). In some embodiments, the dopant precursor includes nitrogen (N). In some embodiments, the dopant precursor includes phosphorus (P). In some embodiments, the dopant precursor includes arsenic (As). In some embodiments, the dopant precursor includes fluorine (F). In some embodiments, the dopant precursor includes chlorine (Cl).

In some embodiments, the dopant includes lithium (Li), sodium (Na), potassium (K), scandium (Sc), yttrium (Y), nitrogen (N), phosphorus (P), arsenic (As), fluorine (F), chlorine (Cl), and combinations thereof.

In some embodiments, the dopant precursor includes lithium (Li), sodium (Na), potassium (K), scandium (Sc), yttrium (Y), nitrogen (N), phosphorus (P), arsenic (As), fluorine (F), chlorine (Cl), and combinations thereof.

In some embodiments:
the electrode for SOR includes beryllium (Be), magnesium (Mg), calcium (Ca), sulfur(S), zinc (Zn), cadmium (Cd), oxygen (O), tellurium (Te), or a combination thereof; and
the ionic-conductive liquid solution further includes a dopant or dopant precursor selected from lithium (Li), sodium (Na), potassium (K), rubidium (Rb), cesium (Cs), francium (Fr), scandium (Sc), Yttrium (Y), lutetium (Lu), lawrencium (Lr), vanadium (V), niobium (Nb), tantalum (Ta), manganese (Mn), technetium (Tc), rhenium (Rh), and combinations thereof.

In some embodiments, the dopant or dopant precursor and hydrogen sulfide are present in the ionic-conductive liquid solution in a molar ratio of about 10⁻⁷ to 1 to about 10⁻¹ to 1.

In some embodiments, the dopant or dopant precursor and hydrogen sulfide are present in the ionic-conductive liquid solution in a molar ratio of about 10⁻⁷ to 1, about 10⁻⁶ to 1, about 10⁻⁵ to 1, about 10⁻⁴ to 1, about 10⁻³ to 1, about 10⁻² to 1, or about 10⁻¹ to 1.

In some embodiments, the dopant or dopant precursor and hydrogen sulfide are present in the ionic-conductive liquid solution in a molar ratio of about 10⁻⁶ to 1 to about 10⁻¹ to 1. In some embodiments, the dopant or dopant precursor and hydrogen sulfide are present in the ionic-conductive liquid solution in a molar ratio of about 10⁻⁵ to 1 to about 10⁻¹ to 1. In some embodiments, the dopant or dopant precursor and hydrogen sulfide are present in the ionic-conductive liquid solution in a molar ratio of about 10⁻⁴ to 1 to about 10⁻¹ to 1. In some embodiments, the dopant or dopant precursor and hydrogen sulfide are present in the ionic-conductive liquid solution in a molar ratio of about 10⁻³ to 1 to about 10⁻¹ to 1. In some embodiments, the dopant or dopant precursor and hydrogen sulfide are present in the ionic-conductive liquid solution in a molar ratio of about 10⁻² to 1 to about 10⁻¹ to 1.

In some embodiments, the dopant or dopant precursor and hydrogen sulfide are present in the ionic-conductive liquid solution in a molar ratio of about 10⁻⁷ to 1 to about 10⁻² to 1. In some embodiments, the dopant or dopant precursor and hydrogen sulfide are present in the ionic-conductive liquid solution in a molar ratio of about 10⁻⁷ to 1 to about 10⁻³ to 1. In some embodiments, the dopant or dopant precursor and hydrogen sulfide are present in the ionic-conductive liquid solution in a molar ratio of about 10⁻⁷ to 1 to about 10⁻⁴ to 1. In some embodiments, the dopant or dopant precursor and hydrogen sulfide are present in the ionic-conductive liquid solution in a molar ratio of about 10⁻⁷ to 1 to about 10⁻⁵ to 1. In some embodiments, the dopant or dopant precursor and hydrogen sulfide are present in the ionic-conductive liquid solution in a molar ratio of about 10⁻⁷ to 1 to about 10⁻⁶ to 1.

The present disclosure further relates to methods of forming hydrogen (H₂) and sulfur(S) from hydrogen sulfide (H₂S), the method including:
forming the ionic-conductive liquid solution including hydrogen sulfide;
contacting an ionic-conductive liquid solution with an electrode for H₂ evolution reaction (HER) and an electrode for sulfur oxidation reaction (SOR) in an electrochemical cell; and
forming the hydrogen and the sulfur.

The present disclosure further relates to methods of forming hydrogen (H₂) and sulfur (S) from hydrogen sulfide (H₂S), the method including:
forming the ionic-conductive liquid solution including hydrogen sulfide;
contacting an ionic-conductive liquid solution with an electrode for H₂ evolution reaction (HER) and an electrode for sulfur oxidation reaction (SOR) in an electrochemical cell;
forming the hydrogen and the sulfur; and
isolating the hydrogen and the sulfur.

The present disclosure further relates to methods of forming hydrogen (H₂) and sulfur (S) from hydrogen sulfide (H₂S), the method including:
forming the ionic-conductive liquid solution including hydrogen sulfide;
contacting an ionic-conductive liquid solution with an electrode for H₂ evolution reaction (HER) and an electrode for sulfur oxidation reaction (SOR) in an electrochemical cell;
applying direct current (DC), alternating current (AC), or both to the electrode for HER and the electrode for SOR, and/or applying sonication to the electrochemical cell;
forming the hydrogen and the sulfur; and
isolating the hydrogen and the sulfur.

The present disclosure further relates to methods of forming hydrogen (H₂) and sulfur(S) from hydrogen sulfide (H₂S), the method including:
contacting an ionic-conductive liquid solution with an electrode for H₂ evolution reaction (HER) and an electrode for sulfur oxidation reaction (SOR) in an electrochemical cell;
applying direct current (DC), alternating current (AC), or both to the electrode for HER and the electrode for SOR, and/or applying sonication to the electrochemical cell; and
forming the hydrogen and the sulfur.

The present disclosure further relates to methods of forming hydrogen (H₂) and sulfur (S) from hydrogen sulfide (H₂S), the method including:
forming the ionic-conductive liquid solution including hydrogen sulfide;
contacting an ionic-conductive liquid solution with an electrode for H₂ evolution reaction (HER) and an electrode for sulfur oxidation reaction (SOR) in an electrochemical cell;
applying direct current (DC), alternating current (AC), or both to the electrode for HER and the electrode for SOR, and/or applying sonication to the electrochemical cell;
forming the hydrogen and the sulfur;
dissolving the sulfur formed on the electrode for SOR;
precipitating the sulfur from the ionic-conductive liquid solution by decreasing the temperature of the ionic-conductive liquid solution; and
isolating the hydrogen and the sulfur.

### Embodiments

Embodiment 1. A method of forming hydrogen (H₂) and sulfur(S) from hydrogen sulfide (H₂S), the method comprising:
contacting an ionic-conductive liquid solution comprising hydrogen sulfide with an electrode for H₂ evolution reaction (HER) and an electrode for sulfur oxidation reaction (SOR) in an electrochemical cell; and
forming the hydrogen and the sulfur.

Embodiment 2. The method of Embodiment 1, further comprising:
isolating the hydrogen and the sulfur.

Embodiment 3. The method of Embodiment 1 or 2, further comprising:
forming the ionic-conductive liquid solution.

Embodiment 4. The method of Embodiment 3, wherein forming the ionic-conductive liquid solution comprises bubbling hydrogen sulfide through an ionic-conductive liquid.

Embodiment 5. The method of any one of Embodiments 1-4, further comprising:
applying direct current (DC), alternating current (AC), or both to the electrode for HER and/or the electrode for SOR.

Embodiment 6. The method of Embodiment 4, wherein the ionic-conductive liquid is an ionic liquid, a natural deep eutectic solvent, a deep eutectic solvent, an organic solvent, an inorganic solvent, or a combination thereof.

Embodiment 7. The method of any one of Embodiments 1-6, wherein the contacting occurs at a temperature of about 5° C. to about 200° C.

Embodiment 8. The method of any one of Embodiments 1-7, wherein the ionic-conductive liquid solution is in direct contact with both the electrode for HER and the electrode for SOR.

Embodiment 9. The method of any one of Embodiments 1-7, wherein the ionic-conductive liquid solution is in indirect contact with one or both of the electrode for HER and the electrode for SOR.

Embodiment 10. The method of Embodiment 9, wherein the indirect contact between the ionic-conductive liquid solution and the electrode for HER and/or the electrode for SOR occurs through a hydrogen ion-conductive material, a sulfur ion-conductive material, an anion exchange membrane, a proton exchange membrane, a cation exchange membrane, or an ion exchange membrane.

Embodiment 11. The method of any one of Embodiments 1-10, wherein the electrode for HER comprises carbon and/or a metal.

Embodiment 12. The method of Embodiment 11, wherein the metal is selected from platinum (Pt), rhodium (Rh), gold (Au), silver (Ag), palladium (Pd), nickel (Ni), and iridium (Ir).

Embodiment 13. The method of any one of Embodiments 1-10, wherein the electrode for HER comprises carbon and/or a metal selected from platinum (Pt), rhodium (Rh), gold (Au), silver (Ag), palladium (Pd), nickel (Ni), and iridium (Ir).

Embodiment 14. The method of any one of Embodiments 1-13, wherein the electrode for SOR comprises an alkali metal, an alkaline earth metal, a group 12 element, a chalcogen, or a combination thereof.

Embodiment 15. The method of any one of Embodiment 1-13, wherein the electrode for SOR comprises lithium (Li), sodium (Na), potassium (K), rubidium (Rb), cesium (Cs), francium (Fr), beryllium (Be), magnesium (Mg), calcium (Ca), strontium (Sr), barium (Ba), radium (Ra), gallium (Ga), oxygen (O), sulfur(S), selenium (Se), tellurium (Te), polonium (Po), zinc (Zn), cadmium (Cd), indium (In), or a combination thereof.

Embodiment 16. The method of any one of Embodiments 1-13, wherein the electrode for SOR comprises beryllium (Be), magnesium (Mg), calcium (Ca), sulfur(S), zinc (Zn), cadmium (Cd), oxygen (O), tellurium (Te), or a combination thereof.

Embodiment 17. The method of any one of Embodiments 1-16, further comprising:
applying sonication or ultrasonication to the electrochemical cell.

Embodiment 18. The method of Embodiment 17, wherein the sonication is applied to the electrode for HER and/or the electrode for SOR.

Embodiment 19. The method of Embodiment 1, wherein:
the electrode for SOR comprises beryllium (Be), magnesium (Mg), calcium (Ca), sulfur(S), zinc (Zn), cadmium (Cd), oxygen (O), tellurium (Te), or a combination thereof; and
the ionic-conductive liquid solution further comprises a dopant or dopant precursor selected from lithium (Li), sodium (Na), potassium (K), rubidium (Rb), cesium (Cs), francium (Fr), scandium (Sc), Yttrium (Y), lutetium (Lu), lawrencium (Lr), vanadium (V), niobium (Nb), tantalum (Ta), manganese (Mn), technetium (Tc), rhenium (Rh), nitrogen (N), phosphorus (P), arsenic (As), fluorine (F), chlorine (Cl), and combinations thereof.

Embodiment 20. The method of Embodiment 19, wherein the dopant or dopant precursor and hydrogen sulfide are present in the ionic-conductive liquid solution in a molar ratio of about 10⁻⁷ to 1 to about 10⁻¹ to 1.

Embodiment 21. The method of any one of Embodiments 1-20, further comprising:
dissolving the sulfur formed on the electrode for SOR.

Embodiment 22. The method of Embodiment 21, wherein dissolving the sulfur comprises applying a direct current (DC) or an alternating current (AC) to the electrode for SOR, or increasing the temperature of the ionic-conductive liquid solution.

Embodiment 23. The method of any one of Embodiments 1-22, further comprising:
precipitating the sulfur from the ionic-conductive liquid solution by decreasing the temperature of the ionic-conductive liquid solution.

Embodiment 24. The method of any one of Embodiments 1-23, wherein the contacting occurs at about 1 atm to about 150 atm pressure.

Embodiment 25. The method of any one of Embodiments 1-24, wherein the method does not decompose a hydrocarbon.

Embodiment 26. A method of forming hydrogen (H₂) and sulfur(S) from hydrogen sulfide (H₂S), the method comprising:
forming the ionic-conductive liquid solution comprising hydrogen sulfide;
contacting an ionic-conductive liquid solution with an electrode for H₂ evolution reaction (HER) and an electrode for sulfur oxidation reaction (SOR) in an electrochemical cell;
   applying direct current (DC), alternating current (AC), or both to the electrode for HER and the electrode for SOR, and/or applying sonication to the electrochemical cell;
forming the hydrogen and the sulfur;
dissolving the sulfur formed on the electrode for SOR;
precipitating the sulfur from the ionic-conductive liquid solution by decreasing the temperature of the ionic-conductive liquid solution; and
isolating the hydrogen and the sulfur.

### EXAMPLES

### Example 1. Sulfur Oxidation Reaction and Hydrogen Reduction Reaction Processes

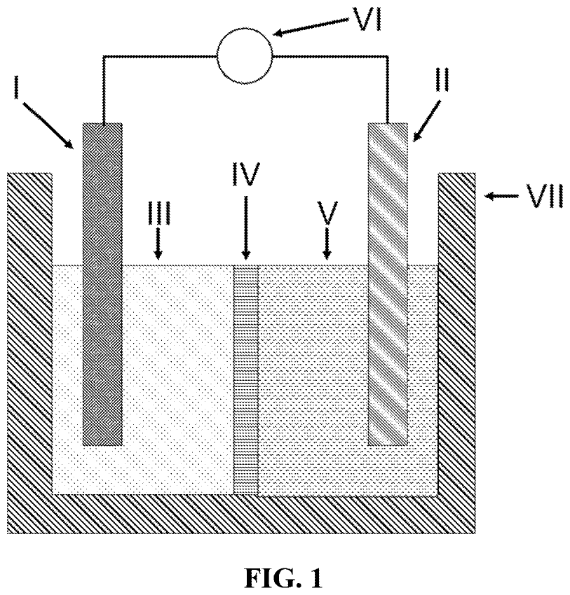

FIGS. 1-3 show exemplary sulfur oxidation reaction and hydrogen reduction reaction processes and exemplary electrochemical cells.

As shown in FIG. 1, the SOR reaction may occur when sulfur is electrodeposited on the electrode surface through the oxidation of HS⁻ and/or Sₙ2− ions. The precursor of sulfur (e.g., hydrogen sulfide) may be dissolved in the ionic-conductive liquid solution. The SOR reaction may occur when sulfur is electrodeposited concurrently with, for example, magnesium (Mg), which may allow a continuous deposition of, for example, magnesium sulfide (MgS) on the original SOR electrode. A dopant precursor, for example, phosphorous, may be added to achieve a P-type conductivity in the MgS electrodeposited and ensure the continuous operation of the process.

As shown in FIG. 1, the HER reaction may be hydrogen gas evolution at the HER electrode. The electrode reduces protonated species in the electrolyte.

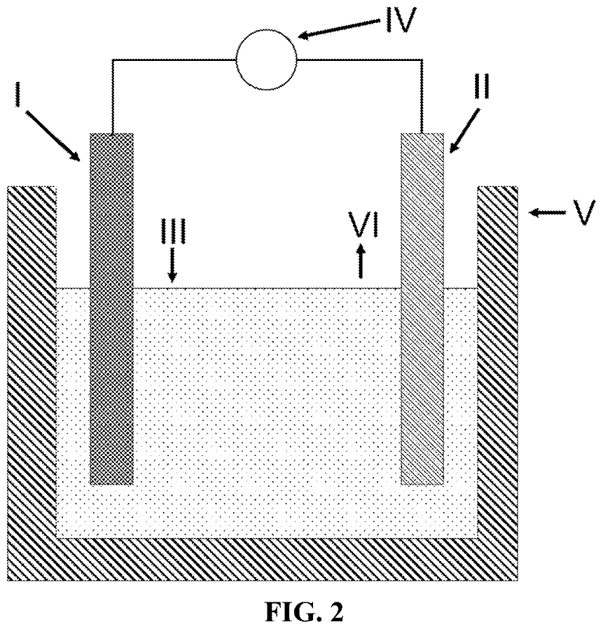

As shown in FIG. 2, the SOR reaction may occur when sulfur is electrodeposited on the electrode surface through the oxidation of HS⁻ and/or Sₙ2− ions. The precursor of sulfur (e.g., hydrogen sulfide) may be dissolved in the ionic-conductive liquid solution. The SOR reaction may occur when sulfur is electrodeposited concurrently with, for example, magnesium (Mg), which may allow a continuous deposition of, for example, magnesium sulfide (MgS) on the original SOR electrode. A dopant precursor, for example, phosphorous, may be added to achieve a P-type conductivity in the MgS electrodeposited and ensure the continuous operation of the process.

As shown in FIG. 2, the HER reaction may be hydrogen gas evoluation at the HER electrode. The electrode formed by, for example, Pt, reduces protonated species in the electrolyte.

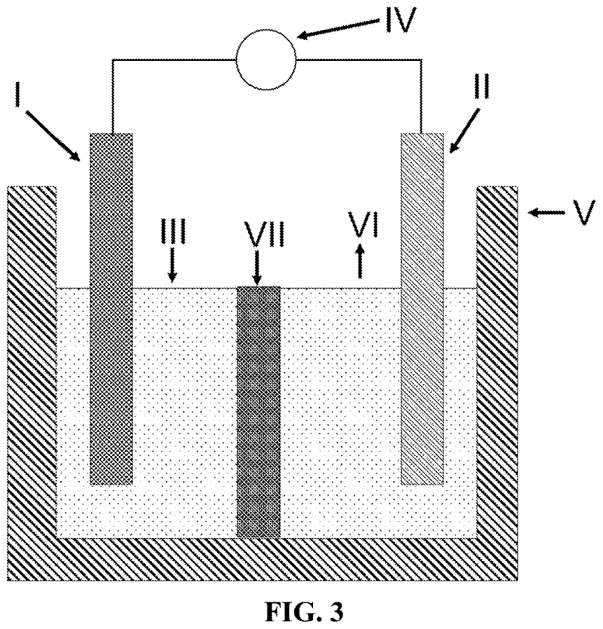

As shown in FIG. 3, the SOR reaction may occur when sulfur(S) is electrodeposited in the electrode surface through the oxidation of HS⁻ and/or Sₙ2− ions. The precursor of sulfur (e.g., hydrogen sulfide) may be dissolved in the ionic-conductive liquid solution. The SOR reaction may occur when sulfur(S) is electrodeposited concurrently with magnesium (Mg), which may allow a continuous deposition of magnesium sulfide (MgS) on the original SOR electrode. A dopant precursor, for example, phosphorous, may be added to achieve a P-type conductivity in the MgS electrodeposited and ensure the continuous operation of the process.

As shown in FIG. 3, the HER reaction may be hydrogen gas evolution at the HER electrode. The electrode formed by, for example, Pt, reduces protonated species in the electrolyte.

### Example 2. Hydrogen Sulfide Dissolution in the Ionic-Conductive Liquid Solution

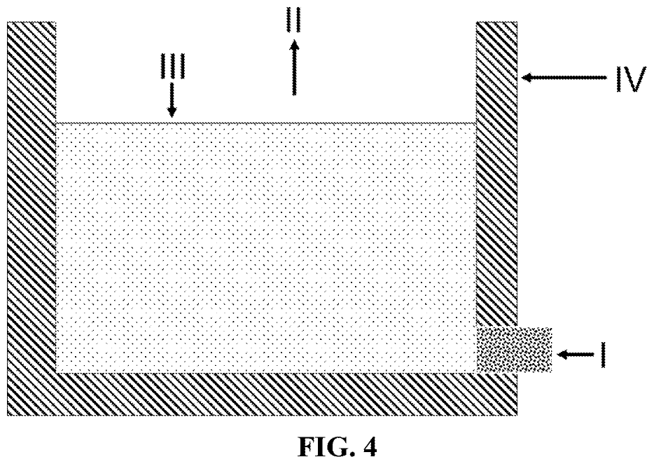

FIG. 4 shows an exemplary process for dissolution of hydrogen sulfide in the ionic-conductive liquid solution. A gas stream containing H₂S may be introduced into the ionic-conductive liquid solution within a temperature- and pressure-controlled electrochemical cell, coupled with ultrasonic capabilities. H₂S-free gas (e.g., hydrogen gas) obtained from the electrochemical cell may form.

### Example 3. Regeneration of Sulfur Oxidation Reaction Electrode

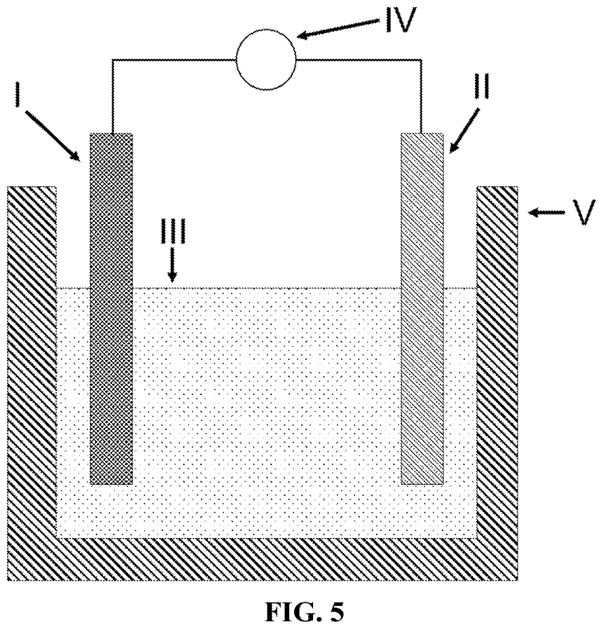

FIG. 5 shows an exemplary SOR regeneration process. A change in ionic-conductive liquid solution temperature may enhance the sulfur solubility of the ionic-conductive liquid solution, which may promote the sulfur removal from the, for example, MgS electrode. Such regeneration process may be enhanced by the application of ultrasonic waves to the cell and/or the application of a voltage to the electrodes.

The reverse reaction driven by applying a voltage to regenerate the SOR electrode during this process, or during its operation in general, once the sulfur has been removed from the solution.

### Example 4. Removal of Sulfur from Ionic-Conductive Liquid Solution by Temperature Gradients

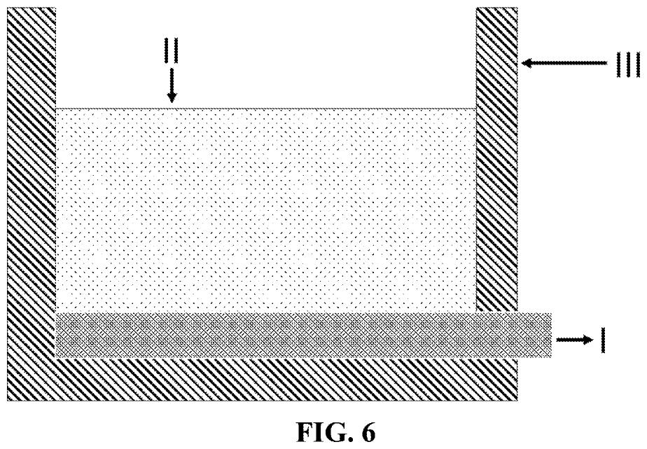

FIG. 6 shows an exemplary process for removal of elemental sulfur removal from electrolyte. After the SOR and HER, the temperature of the electrolyte may be decreased to enhance the precipitation of elemental sulfur, which can then be removed, leaving the electrolyte ready for another cycle of the catalytic method.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method of forming hydrogen (H₂) and sulfur(S) from hydrogen sulfide (H₂S), the method comprising:
contacting an ionic-conductive liquid solution comprising hydrogen sulfide with an electrode for H₂ evolution reaction (HER) and an electrode for sulfur oxidation reaction (SOR) in an electrochemical cell; and
forming the hydrogen and the sulfur.

2. The method of claim 1, further comprising:
isolating the hydrogen and the sulfur.

3. The method of claim 1, further comprising:
forming the ionic-conductive liquid solution, comprising bubbling hydrogen sulfide through an ionic-conductive liquid prior to contacting the ionic-conductive liquid solution comprising hydrogen sulfide with the electrode for H₂ evolution reaction (HER) and the electrode for sulfur oxidation reaction (SOR) in the electrochemical cell.

4. The method of claim 1, further comprising:
applying direct current (DC), alternating current (AC), or both to the electrode for HER and the electrode for SOR after contacting the ionic-conductive liquid solution comprising hydrogen sulfide with the electrode for H₂ evolution reaction (HER) and the electrode for sulfur oxidation reaction (SOR) in the electrochemical cell.

5. The method of claim 3, wherein the ionic-conductive liquid is an ionic liquid, a natural deep eutectic solvent, a deep eutectic solvent, an organic solvent, an inorganic solvent, or a combination thereof.

6. The method of claim 3, wherein the ionic-conductive liquid comprises a deep eutectic solvent and an ionic liquid.

7. The method of claim 3, wherein the ionic-conductive liquid comprises water.

8. The method of claim 1, wherein the ionic-conductive liquid solution is in direct contact with both the electrode for HER and the electrode for SOR.

9. The method of claim 1, wherein the ionic-conductive liquid solution is in indirect contact with one or both of the electrode for HER and the electrode for SOR.

10. The method of claim 1, wherein the electrode for HER comprises carbon (C), platinum (Pt), rhodium (Rh), gold (Au), silver (Ag), palladium (Pd), nickel (Ni), iridium (Ir), and combinations thereof.

11. The method of claim 1, wherein the electrode for HER comprises carbon (C), platinum (Pt), rhodium (Rh), palladium (Pd), and combinations thereof.

12. The method of claim 1, wherein the electrode for SOR comprises lithium (Li), sodium (Na), potassium (K), rubidium (Rb), cesium (Cs), francium (Fr), beryllium (Be), magnesium (Mg), calcium (Ca), strontium (Sr), barium (Ba), radium (Ra), gallium (Ga), oxygen (O), sulfur(S), selenium (Se), tellurium (Te), polonium (Po), or a combination thereof.

13. The method of claim 1, wherein the electrode for SOR comprises beryllium (Be), magnesium (Mg), calcium (Ca), sulfur(S), zinc (Zn), cadmium (Cd), oxygen (O), tellurium (Te), or a combination thereof.

14. The method of claim 1, wherein the dopant comprises lithium (Li), sodium (Na), potassium (K), scandium (Sc), yttrium (Y), nitrogen (N), phosphorus (P), arsenic (As), fluorine (F), chlorine (Cl), or a combination thereof.

15. The method of claim 1, further comprising:
applying sonication or ultrasonication to the electrochemical cell.

16. The method of claim 1, wherein:
the electrode for SOR comprises beryllium (Be), magnesium (Mg), calcium (Ca), sulfur(S), zinc (Zn), cadmium (Cd), oxygen (O), tellurium (Te), or a combination thereof; and
the ionic-conductive liquid solution further comprises a dopant or dopant precursor selected from lithium (Li), sodium (Na), potassium (K), rubidium (Rb), cesium (Cs), francium (Fr), scandium (Sc), Yttrium (Y), lutetium (Lu), lawrencium (Lr), vanadium (V), niobium (Nb), tantalum (Ta), manganese (Mn), technetium (Tc), rhenium (Rh), nitrogen (N), phosphorus (P), arsenic (As), fluorine (F), chlorine (Cl), or a combination thereof.

17. The method of claim 16, wherein the dopant or dopant precursor and hydrogen sulfide are present in the ionic-conductive liquid solution in a molar ratio of about 10⁻⁷ to 1 to about 10⁻¹ to 1.

18. The method of claim 1, further comprising:
dissolving the sulfur formed on the electrode for SOR, comprising applying a direct current (DC) or an alternating current (AC) to the electrode for SOR, or increasing the temperature of the solvent.

19. The method of claim 1, further comprising:
precipitating the sulfur from the ionic-conductive liquid solution by decreasing the temperature of the solvent.

20. A method of forming hydrogen (H₂) and sulfur(S) from hydrogen sulfide (H₂S), the method comprising:
forming the ionic-conductive liquid solution comprising hydrogen sulfide;
contacting an ionic-conductive liquid solution with an electrode for H₂ evolution reaction (HER) and an electrode for sulfur oxidation reaction (SOR) in an electrochemical cell;
applying direct current (DC) the electrode for HER and the electrode for SOR, alternating current (AC) the electrode for HER and the electrode for SOR, sonication to the electrochemical cell, or combinations thereof;
forming the hydrogen and the sulfur;
dissolving the sulfur formed on the electrode for SOR;
precipitating the sulfur from the ionic-conductive liquid solution by decreasing the temperature of the solvent; and
isolating the hydrogen and the sulfur.
